(19) United States
(12) Patent Application Publication
(10) Pub. No.: US 2013/0142457 A1
(43) Pub. Date: Jun. 6, 2013

(54) COMPONENT, IN PARTICULAR FOR A FITTING, A PIECE OF FURNITURE AND/OR A DOMESTIC APPLIANCE, METHOD FOR PRODUCING A COMPONENT, AND A FITTING, PIECE OF FURNITURE AND/OR DOMESTIC APPLIANCE

(71) Applicants: Peter Jährling, Bunde (DE); Daniel Rehage, Bielefeld (DE); Uwe Sobolewski, Bunde (DE); Lars Schrubke, Kirchlengern (DE); Willi Grigat, Gutersloh (DE); Arthur Krause, Lubbecke (DE); Björn Gebhardt, Oelde (DE)

(72) Inventors: Peter Jährling, Bunde (DE); Daniel Rehage, Bielefeld (DE); Uwe Sobolewski, Bunde (DE); Lars Schrubke, Kirchlengern (DE); Willi Grigat, Gutersloh (DE); Arthur Krause, Lubbecke (DE); Björn Gebhardt, Oelde (DE)

(73) Assignee: PAUL HETTICH GMBH & CO. KG, Kirchlengern (DE)

(21) Appl. No.: 13/704,709

(22) PCT Filed: Jun. 1, 2011
(86) PCT No.: PCT/EP2011/059070

§ 371 Date: Feb. 22, 2013

(30) Foreign Application Priority Data
Jun. 17, 2010 (DE) 10 2010 017 438.6

(51) Int. Cl. A47B 88/04; B29C 67/00

(52) U.S. Cl. CPC A47B 88/04; B29C 67/00
USPC 384/7; 264/134

(57) ABSTRACT

A component for one or more of a fitting, a piece of furniture, and a domestic appliance. The component includes a formed body including one or more of a hard-material-containing composite, a metal-ceramic composite, and a hard material. A method of producing the component includes providing the formed body and shaping it by thermal spraying or mechanical forming.

### CROSS-REFERENCE TO RELATED APPLICATION

This application is a national stage of International Application PCT/EP2011/059070, filed Jun. 1, 2011, and claims benefit of and priority to German Patent Application No. 10 2010 017 438.6, filed Jun. 17, 2010, the content of which Applications are incorporated by reference herein.

### BACKGROUND SUMMARY

The present disclosure relates to a component for one or more of a fitting, a piece of furniture, and a domestic appliance. The present disclosure also relates to a method for producing the component. The present disclosure further relates to a fitting, a piece of furniture, and a domestic appliance that includes the component.

Coated stainless special steels with hard-material-containing composite material coatings were used up until now in the field of fittings, for example, as published in DE 10 2010 016 911.0. Stainless special steels in the field of fittings are characterized by their strength and corrosion resistance. However, the use of stainless special steels is problematic in the area of high-temperature applications due to scaling effects. Stainless special steel is furthermore a relatively expensive starting material for the production of fittings.

DE 199 51 689 C1 discloses a guide grating for ovens, that is made as shaped bodies made of plastic, metal, graphite or ceramic materials. A coating made of a high-temperature resistant and hard material can optionally be applied to these shaped bodies for increasing the strength, for example, a hard-material coating.

DE 1 629 426 discloses a laminate with a surface layer consisting of a resin compound, which additionally comprises hard materials such as diamonds or titanium carbide, for example.

AT 350 285 also discloses different articles of daily use which are provided with a hard-material coating.

Finally, WO 2009/135148 A2 discloses a radiator coating made of a carbide-containing coating material.

All these documents merely disclose coatings, that is, thin layers of material, which, in the case of a pull-out guide, can be removed by regular use. Furthermore, such a coating, when used in ovens, can detach after some time from a mechanically highly loaded component because differences in the material extension between the coating and the coated base body can arise by continual heating and cooling.

Embodiments of the present disclosure for a component which offers high scratch resistance and material strength even after prolonged use and under changing temperatures.

Embodiments according to the present disclosure are discussed further herein.

Embodiments according to the present disclosure are directed to a component for one or more of a fitting, a piece of furniture, and a domestic appliance. The component includes a formed body including one or more of a hard-material-containing composite, a metal-ceramic composite, and a hard material. Embodiments according to the present disclosure also are directed to a method for producing a component for one or more of a fitting, a piece of furniture, and a domestic appliance. The method steps include: providing a formed body including one or more of a hard-material-containing composite, a metal-ceramic composite, and a hard material; and shaping the formed body by one of thermal spraying and mechanical forming.

The formed body will be formed from a material composition and comprises a composite material with homogeneously distributed hard material particles or a single material composition for a hard-material or metal-ceramic composite.

The formed body is, advantageously, free from coatings, but may, for example, be provided with a functional coating depending on the respective application. As a result, the running surfaces of a rail of a pull-out guide, for example, may be provided with a sliding coating.

The component can be used, for example, as a fitting in any kind of furniture, and, for example, in domestic appliances including white ware, such as refrigerators and ovens, also including those with pyrolysis cleaning, freezers, washing machines, dishwashers, and tumble dryers, for example. Side gratings, foodstuff racks, gratings, fat pans, for example, for ovens, are fittings within the scope of the present disclosure.

In the embodiments of the present disclosure, the use of special stainless steel in fittings may omitted. This leads to a considerable price advantage and an advantage in transport as a result of a lower mass. In contrast to the use of coatings, any damage to the surface will not have any effect on the underlying material of the formed body. Service life of the component, in accordance with embodiments of the present disclosure, is considerably longer in comparison with coated formed bodies made of special stainless steel.

Embodiments of the present disclosure are also discussed in the appended claims.

According to embodiments of the present disclosure, it is advantageous for the formed body, of the embodiments to have a Vickers hardness number of more than 300 HV10, where, for example, 300=hardness number, HV=process and 10=testing force in kilopond. The Vickers hardness number may also be, for example, between 500 to 1000 HV10 or between 600 to 750 HV10. These hardness numbers advantageously ensure increased scratch resistance of the surface of the formed body.

According to embodiments of the present disclosure, it is advantageous for the use of the component, for example, in the area of ovens as a pull-out guide or foodstuff rack, when the melting point of the formed body is, for example, higher than 300° C., or, for example, between 400 to 1200° C., or between 500 to 700° C. This corresponds to the temperature which can be achieved with a conventional oven. The component, according to the present disclosure, can also be used in pizza ovens which usually have a temperature of 400 to 500° C. over a prolonged period of time. In a number of embodiments of the components according to the present disclosure, even the use in furnaces with operating temperatures of 1000 to 1100° C. is ensured.

According to embodiments of the present disclosure, it is advantageous when the composite has a mass fraction of more than 50% of a metal and/or a ceramic material. For example, in the case of a formed body made of a hard-material-containing material, the ductility of the metallic matrix and the flexibility and deformability of the metal can be used advantageously, for example, for processing and shaping. In the case of a ceramic formed body, its brittleness caused by the microstructure adjustment, for example, can be optimized advantageously.

Hard materials chosen from a group consisting of carbides, nitrides, borides or silicides are, for example, advantageous for increasing the scratch resistance of the formed body. The effect of scratch resistance, is advantageously, amplified, for example, by carbides, nitrides, borides or silicides of transitional metals of high melting points such as titanium, tantalum, tungsten and molybdenum, including their mixed crystals and complex compounds.

Corundum, fluorapatite or mixtures thereof can, for example, be used as hard materials. These hard materials occur naturally. Fluorapatite, like corundum, is generally recognized as not being harmful to health and can be used in fittings which are used in the area of foodstuffs such as ovens or refrigerators.

The friction of components of a fitting which are movable against one another, such as a pull-out guide or hinge, can be reduced by a lubricant.

The component, in accordance with embodiments of the present disclosure, meets the Regulation (EC) No. 1935/2004 of the European Parliament and the Council of 27 Oct. 2004 on materials and items which are designated to come into contact with foodstuffs and for lifting the Directive 80/590/EEC and 89/109/EEC.

In accordance with the present disclosure, a method for producing embodiments of a component in accordance with the present disclosure comprises the step of shaping by one of a thermal injection and mechanical forming, for example, by bending and punching.

The manner of shaping can vary according to the composite. As a result, many hard-material-containing metal composites can, for example, be processed by bending and punching, whereas the shaping of hard-material-containing ceramic components can, for example, occur by thermal injection.

Other aspects of the present disclosure will become apparent from the following descriptions when considered in conjunction with the accompanying drawings.

### BRIEF DESCRIPTION OF THE DRAWINGS

FIGS. 1 to 3 show several views of an embodiment of a metallic component in accordance with the present disclosure, which is arranged, for example, as a fitting in the form of a pull-out guide.

### DETAILED DESCRIPTION

A pull-out guide 1 comprises a guide rail 2 which can, for example, be fixed to a side grating in an oven, to a side wall of an oven or to a furniture body. A middle rail 3 is held on the guide rail 2 in a displaceable manner by way of rolling bodies 6. The middle rail 3 is used for bearing a running rail 4. At least two running tracks 9 for the rolling bodies 6, shown, for example, as three running tracks 9, are arranged on the guide rail 2 and the running rail 4 for bearing the rails 2, 3 and 4. The rolling bodies 6 are held in a rolling body cage 7 as a unit. Furthermore, a total of at least four running tracks 8, shown, for example, as six running tracks 8, for rolling bodies 6 are arranged in the middle rail 3, with at least two running tracks 8 being associated with the guide rail 2 and at least two running tracks 8 with the running rail 4.

Two clamps 5 are fixed to the guide rail 2 for fixing the pull-out guide 1 to, for example, a side grating of an oven. Other fixing elements or fixing points can, in accordance with the present disclosure, be provided on the guide rail 2.

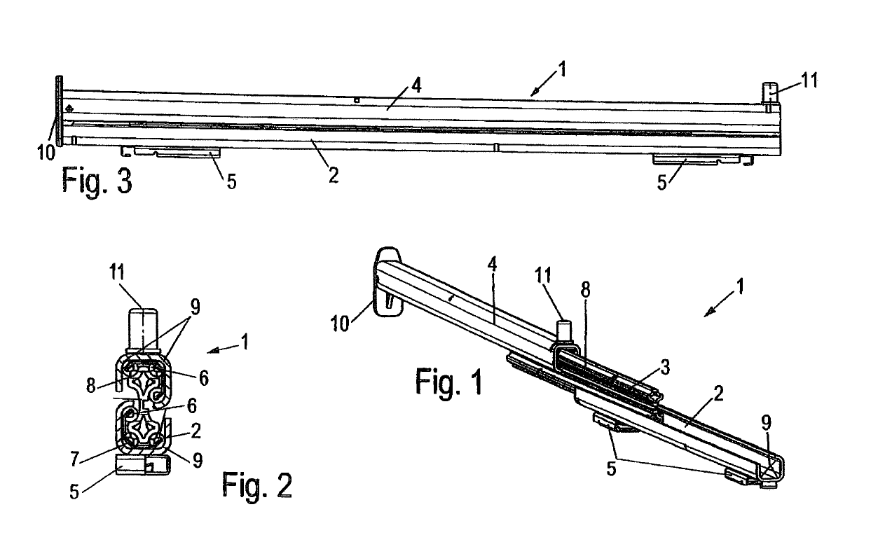

The guide rail 2, the middle rail 3 and the running rail 4 include a hard-material-containing ceramic material, for example. A plug 10, fixed to the running rail 4, and a holding bolt 11 are also made of this same material, for example. The middle rail 3 is completely arranged in the interior region of the pull-out guide 1 when the running rail 4 is in the retracted position. As a result, the running tracks 8 can, for example, be formed by the material of the rails 2, 3 and 4. The running tracks 8 and 9 are formed, for example, from a hard-material-containing composite by thermal injection. As a result, the pull-out guide 1 can, for example, be used advantageously in an oven, with a high running quality being achieved over a long service life. FIGS. 1 to 3 show, for example, an overextension pull-out with three rails 2, 3 and 4. An embodiment with at least three rails with a full-extension pull-out is also within the scope of the present disclosure. It is also within the scope of the present disclosure, to arrange the pull-out guide 1 as a partial pull-out with only two rails, for example, without the middle rail 3, or with more than three rails.

The term component shall include, for example, regarding pull-out guides, at least the running and guide rails 4, 3, respectively. Rolling bodies shall not be included when referring to the term component or to formed bodies, within the terms of the present disclosure.

Components, including a composite, in accordance with the present disclosure are, for example, wood, glass and polymers, and, for example, ceramic materials and metals, which in conjunction with hard-material layers or hard-material particles are processed into layered and particle composites. Particle composites include hard metals and ceramic materials, for example. Fiber composites, in accordance with the present disclosure, are also included in the wider sense in the composites of the formed body of the component in accordance with the material of the present disclosure.

Formed bodies made of hard materials are produced, for example, at temperatures of over 2000° C. Hard-material-containing composites can, for example, be formed in an advantageous manner already at considerably lower temperatures.

It is, therefore, sufficient in thermal injection methods, for example, in the case of injection molding, to liquefy the low-melting fractions of the composite matrix. Whereas, the mostly higher melting hard-material components are already entrained by the liquid composite matrix and will distribute homogeneously in the melt.

The hard materials, which are contained in the formed body, are substances which as a result of their specific bonding character have a Vickers hardness of more than 1000 HV10, where, for example, 1000=hardness value, HV=process and 10=testing force in kilopond or more than 3000 HV10. The melting point of hard materials mostly lies over 2000° C. In addition to corundum, hard materials may be, in accordance with the present disclosure, carbide, nitride, boride and silicide compounds. The most important representatives of the class of hard materials are diamond, cubic crystalline boron nitride, silicon carbide, aluminum oxide, boron carbide, tungsten carbide, vanadium carbide, titanium carbide, titanium nitride and zirconium dioxide.

The composite material can be formed, in accordance with the present disclosure, additionally or alternatively on the basis of a metal-ceramic composite, or cermet. Cermet is a designation translated as metal-ceramic or ceramal for a group of materials made of two separate phases with a metallic and ceramic component, which phases differ from one another in respect of hardness and melting point. An increase in the ceramic fraction leads to an increase in the hardness, the melting point, resistance to heat and scaling resistance. The metallic fraction, on the other hand, improves temperature resistance, thermal shock resistance, tenacity and impact resistance of the metallic component.

In an embodiment of the present disclosure, for example, for the use in ovens, which may be with pyrolysis function, and pizza ovens, the pull-out guide 1 comprises one or several formed bodies made of hard-metal-containing composite which includes a high-temperature material. This component in form of a fitting can, for example, be used at temperatures of over 500° C., that is, at temperatures which occur in an oven with pyrolysis operation, in which conventional fittings have a tendency towards partial scaling.

Advantageous high-temperature materials, in accordance with the present disclosure, are Al₂O₃, BeO, CaO, MgO, SiO₂, ThO₂ or ZrO₂, and carbon materials, especially coal and graphite. The latter two show low thermal expansion in combination with high thermal conductivity and excellent thermal shock resistance. Furthermore, carbides, nitrides and aluminides, such as HfC, TaC, ZrC, SiC, beryllium, boron, aluminum and silicon nitrides, and aluminides of the metals of nickel and iron, can, for example, be used as high-temperature materials.

In an embodiment of the present disclosure, for example, for use in ovens, the pull-out guide 1 may comprise components made of a hard-metal-containing composite with at least one ceramic material, for example, a high-performance ceramic.

This ceramic material includes a volume fraction of more than 30% of crystalline materials. The high-performance ceramic comprises high-purity oxides, nitrides, carbides and borides of precisely defined composition, particle shape and particle size distribution, and is also processed as a powder by pressing and sintering into contact bodies, with optimal microstructure adjustment being ensured. The mean particle size of the hard materials can be, for example, between 0.01 to 200 μm, or, for example, between 0.1 and 20 μm. The properties of the formed body of the metallic component when using a high-performance ceramic depend on the structure to a substantially higher extent than in the case of metallic materials.

Hard-material-containing high-performance ceramic materials may include, for example, aluminum oxide (corundum, Al₂O₃), zirconium dioxide (ZrO₂), silicon nitride (Si₃N₄), aluminum nitride (AlN), silicon carbide (SiC), boron carbide (B₄C) and titanium diboride (TiB₂). Fittings, in accordance with embodiments of the present disclosure, made of high-performance ceramics are resistant to high temperatures, corrosion-proof and wear-proof. They offer resistance to pressure, hardness and resistance to creep, and favorable sliding properties in combination with simultaneously high thermal and chemical resistance. In addition, they can assume electrical, magnetic and optical functions.

The high-performance ceramics can be mixed with hard materials as a powder composition and thereafter be formed into a formed body. This enables a defined grain size distribution and a defined surface. The formed body has a high packing density of the powder particles in the material matrix, leading to a high sintering density in combination with the lowest possible shrinkage.

Slip-cast components with high-performance ceramics, in accordance with the present disclosure, can also have a higher packing density and therefore a lower pore size distribution in comparison with cold-pressed bodies.

High sintering temperatures and/or high external pressures are necessary for advantageously setting the structure in the hard-material-containing material with a predominant fraction of high-performance ceramics. This is advantageous in order to accelerate the grain-boundary diffusion-controlled material transport at reduced fluid-phase fraction in Si₃N₄ and AlN ceramics, for example. In order to prevent the disintegration of Si₃N₄ at sintering temperatures of over 1800° C., gas-pressure sintering with an N₂ pressure of 1 to 10 MPa is applied, in accordance with the present disclosure, which enables sintering temperatures of over 2000° C. As a result, the anisotropic grain growth can be utilized in a purposeful manner and a structure with low intergranular glass fraction but high degree of stretching of the crystallization can be produced. This additionally improves fracture toughness and high-temperature resistance of the component in accordance with the present disclosure.

Hot isostatic pressing methods for encapsulated or pre-sintered hard-material-containing ceramic composites can also be applied in accordance with the present disclosure. This occurs with gas pressures of up to 200 MPa under an Ar, N₂ or O₂ atmosphere at temperatures of up to 2000° C. in order to advantageously achieve a complete compression of the hard-material-containing composite ceramics. As a result of the combination of pressureless sintering, gas-pressure sintering and hot isostatic pressing in a compression process optimized to the respective material, it is managed to produce more homogeneous structures with lower grain growth, lower error size and higher density in hard-material-containing composites made of oxide and non-oxide ceramics.

Hard-material-containing composites with novel structures and properties can be produced by chemical reaction processes. It is within the scope of the present disclosure to also utilize autocatalytic reaction processes (Al₂O₃/B₄C), displacement reactions (Al₂O₃/TiN) and eutectic crystallization (Al₂O₃/ZrO₂), reactions of organometallic compounds as (SiC/SiO₂) polymer reaction techniques (Si₃N₄/SiC), melting-phase filtration techniques (Si/SiC), directed melt oxidation (Al₂O₃/Al), and gas-phase filtration/separation (BN, SiC/SiC).

The reaction processes in accordance with the present disclosure offer advantages over conventional methods for the formed body of a metallic component because, on the basis of pure starting substances, they offer easy shaping, low shrinkage and high dimensional stability as well as a reduction of structural tensions in hard-material-containing composites.

In an embodiment according to the present disclosure, the hard-material particles of the composite are made of corundum, with the composite additionally being reinforced by fibers, for example, alpha-aluminum oxide fibers. The composite material is advantageously resistant to temperature shocks, scratch-proof and temperature-resistant at temperatures of up to 800° C. Such components and fittings can be used in ovens with pyrolysis operation in accordance with the present disclosure.

In an advantageous use of corundum as a hard material, in accordance with the present disclosure, this powder is pulverized and ground with a mass fraction of 8 to 25% of a bonding agent made of clay, quartz or a polymer, processed in a humidified manner in an injection or extrusion process into a formed part and baked at 1300 to 1400° C. The individual components will sinter into a uniform composite.

Alpha-aluminum oxide fibers, such as saphibres, can additionally be added to the corundum-bonding agent compound as an advantageous embodiment of a hard-material-containing composite, and subsequently this compound can be formed into a formed part by extrusion, in accordance with the present disclosure.

Within the scope of the present disclosure, a component of an advantageous hard-material-containing composite material can be a magnesium oxide ceramic material which was mixed with hard-material particles, in accordance with the embodiment of the present disclosure. Magnesium oxide ceramic is a material sintered from magnesium oxide, for example, periclase, or magnesium aluminate, for example, spinel. The melting point of such a component lies above 1500° C., so that such a component can be used as a fitting itself in sintering furnaces, for example.

Such a component is suitable for special applications in the refractory industry, for example, in muffle furnaces or in the field of metallurgy. The MgO-based embodiment of the component of the present disclosure shows a very high resistance to corrosion, for example, in the alkaline environment. Magnesium oxide can also be used in other ceramic materials for performing formed bodies, for example, in Al₂O₃ ceramics, in order to advantageously obstruct grain growth during sintering.

In an embodiment according to the present disclosure, the formed body comprises a ceramic composite with zirconium oxide.

Furthermore, a composite can include metallic nitrides as hard materials in accordance with the present disclosure. Advantageous examples are nitrides of the transition metals, such as VN, CrN, W₂N, in which the nitrogen atoms occupy the cavities of the metal structure and have metallic character in respect of appearance, hardness and electrical conductivity. In addition to the hardness, a metallic appearance of the component can be produced thereby. A composite with nitrides as hard materials can be produced, in that a chromium steel melt is introduced under N₂ pressure up to a mass fraction of 1.8% nitrogen under formation of iron nitride hard materials, and a metallic composite of higher strength, as compared with conventional chromium steel, can be produced thereby with the metal matrix.

Covalent nitrides, which are considered as hard materials for the composite, are mainly formed by elements of the thirteenth group such as BN, AlN, InN, GaN and Si₃N₄. The formed body from the hard-material-containing composite which is produced therefrom is chemically stable. The nitrides which are present as hard-material components in the composite may, for example, be produced by solid-body reactions.

In an embodiment according to the present disclosure, the formed body of the component comprises aluminum nitride as the hard-material component. The hard material shows very good thermal conductivity and strength in combination with low thermal expansion and can be used, for example, in an advantageous way in ceramic formed bodies in conjunction with silicon and boron nitride.

In an embodiment according to the present disclosure, carbides can be used as a hard-material component in a composite. Covalent carbides and metallic carbides are advantageous as hard materials. This comprises compounds of carbon with non-metals whose bonding partner is less electronegative than carbon, such as boron carbide and silicon carbide, and non-stoichiometric compounds of transition metals with carbons of an alloy nature. They are resistant to acids. The relatively small carbon atoms are disposed in the gaps of the metallic lattice.

The formation of carbide on the surface of a metallic component or fitting component can occur by reaction of elementary carbon or gases emitting carbon with the metallic surface of the metallic starting materials prior to shaping at 1200 to 2300° C. This carburetion is advantageously performed under protective gas or in vacuum.

Boron carbide or silicon carbide can be used, for example, in an embodiment of the present disclosure as hard-material particles in the formed body of a component. Hard materials to be considered for the composite also include, for example, borides as non-stoichiometric compounds of boron and a metal, which can be produced by powder metallurgy or by reaction of the metal oxides with boron carbide.

Titanium diboride is advantageous when used as boride hard materials in the formed body of the present disclosure.

In an embodiment in accordance with the present disclosure, the composite material can include mainly metal-ceramic composite material, or cermet. For producing a cermet, a ceramic powder composition is mixed with metal powders, the mixture is pressed under high pressure into a formed body and is sintered under neutral or weak acidic reducing atmosphere.

Fiber-reinforced hard-material-containing materials are advantageous for producing a component such as a fitting which is subjected to high mechanical loads. Pull-out guides, on which a foodstuff rack is disposed, are subjected to such loads in the field of ovens, for example.

The hard-material-containing composite formed body can advantageously be fiber-reinforced for the purpose of better distribution of forces under point-like loads. So-called biomorphous ceramic materials, on the basis of cellulose-containing starting materials, are advantageous. The starting materials for the fibers can be, for example, natural wood or wood-based materials. Natural wood is characterized by its mechanically efficient plant fiber designs. The process of liquid siliconization, or LSI, can be used for producing SiC ceramics of wood or wood-based materials for use of formed bodies in fitting components in accordance with the present disclosure. For this purpose, the wood-based material is pyrolized in a first step under inert gas conditions. The obtained cellular or porous carbon formed body, or C-template, is subsequently infiltrated with liquid silicon. Silicon reacts with the carbon to silicon carbide. Depending on the starting material and the process control, it is within the scope of the present disclosure to produce dense or porous, SiC—, SiC ceramics which show very different microstructures and therefore also very different properties as a result of the variable structural configuration.

An embodiment, in accordance with the present disclosure, for shaping a formed body from a hard-material-containing composite, a metal-ceramic composite and/or a hard material is the thermal injection process by flame-spraying, detonation spraying, arc spraying, plasma spraying or plasma spraying under vacuum.

Composite materials which are made up from a ceramic matrix and additionally comprise fiber reinforcement are advantageous. This fiber reinforcement is enabled, for example, by incorporating fiber mats or fiber bundles or by a winding process of fibers.

The fibers can include any temperature-resistant organic or inorganic material. For example, the fibers may also be made of a ceramic material, for example, of glass fibers.

Higher ductility and higher resistance to thermal shocks of the composite in comparison with purely monolithic ceramic materials is achieved by a weak fiber-matrix linkage of the fiber-reinforced composite material, in accordance with the present disclosure.

A porous ceramic material or an oxide ceramic material is suitable, in an advantageous manner, in accordance with the present disclosure, as materials for a ceramic matrix because oxide ceramics substantially maintain their properties even under high temperatures in an oxygen-containing atmosphere and porous ceramics achieve advantageously high ductility by merely local fiber/matrix contacts.

The fiber reinforcement can advantageously be embedded during thermal spraying in the ceramic matrix or can be introduced into the matrix by pressing processes.

This embodiment, according to the present disclosure, of fiber-reinforced composites is advantageously used in the field of pull-out guides and foodstuff racks for high-temperature applications, such as in ovens with temperatures of over 250° C., where the contained hard materials provide high and constant scratch resistance and the fiber reinforcement prevents potential microfractures during rapid cooling.

The oven is often preheated, so that the pull-out guides, in accordance with the present disclosure, in the oven already have temperatures of between 250 and 300° C. before a foodstuff rack such as a baking sheet at −15 to 25° C. is inserted into the oven.

In addition to the pull-out guide of embodiments of the present disclosure, the foodstuff rack may advantageously be included as a component in an oven, including ovens with pyrolysis cleaning.

As a result of the advantageously high temperature shock stability, the hot pull-out guide, in accordance with the present disclosure, can also come into contact with cold foodstuff racks without producing any stress cracks in the formed body. The placement of hot foodstuff racks from the oven on a cold surface, such as kitchen tiles, does not lead to material cracks in the formed body of the foodstuff rack.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A component for one or more of a fitting, a piece of furniture, and a domestic appliance, the component comprising:
a formed body including one or more of a hard-material-containing composite, a metal-ceramic composite, and a hard material.

2-11. (canceled)

12. The component according to claim 1, wherein the formed body has a Vickers hardness of more than 300 HV10.

13. The component according to claim 1, wherein the melting point of the formed body is higher than 300° C.

14. The component according to claim 1, wherein one or both of the composites includes at least one hard material and at least one of a metal, a ceramic material, a fiber material, and a plastic material.

15. The component according to claim 1, wherein one or both of the composites includes a hard material and at least one of a metal, an alloy, and a ceramic material.

16. The component according to claim 1, wherein each of the composites and the hard material includes a hard material selected from a group consisting of carbides, nitrides, borides, and silicides.

17. The component according to claim 1, wherein each of the composites and the hard material includes one or more of corundum, fluorapatite, silicon nitride, and molybdenum silicide.

18. A method for producing a component for one or more of a fitting, a piece of furniture, and a domestic appliance, the method steps comprising:
providing a formed body including one or more of a hard-material-containing composite, a metal-ceramic composite, and a hard material; and
shaping the formed body by one of thermal spraying and mechanical forming.

19. A domestic appliance including a component arranged in one of in and on the domestic appliance, the component comprising a formed body including one or more of a hard-material-containing composite, a metal-ceramic composite, and a hard material.

20. A piece of furniture including a component arranged one of in and on the piece of furniture, the component comprising a formed body including one or more of a hard-material-containing composite, a metal-ceramic composite, and a hard material.

21. A fitting including a component arranged one of in and on the fitting, the component comprising a formed body including one or more of a hard-material-containing composite, a metal-ceramic composite, and a hard material.

22. The component according to claim 1, wherein the formed body has a Vickers hardness of 500-1000 HV10.

23. The component according to claim 1, wherein the formed body has a Vickers hardness of 600-750 HV10.

24. The component according to claim 1, wherein the melting point of the formed body is 400-1200° C.

25. The component according to claim 1, wherein the melting point of the formed body is 500-700° C.

26. The method of claim 18, wherein the mechanical forming includes one or more of bending and punching.
